(19) United States
(12) Patent Application Publication
(10) Pub. No.: US 2005/0126320 A1
(43) Pub. Date: Jun. 16, 2005

(54) Rotating mechanism

(75) Inventor: Li-Chieh Cheng, Taipei (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 10/869,708

(22) Filed: Jun. 16, 2004

(30) Foreign Application Priority Data
Dec. 11, 2003 (TW) TW92134987

(51) Int. Cl. B62C 1/06

(52) U.S. Cl. 74/63

(57) ABSTRACT

A rotating mechanism. The rotating mechanism comprises a fixed member, a first rotating member, a second rotating member, a restricting member and a first resilient element. The second rotating member has an abutting portion, and the restricting member movably connects to the first rotating member and contacts the abutting portion. The first resilient element connects the fixed member and the first rotating member. Moreover, the first resilient element provides a spring force rotating the first rotating member, wherein the restricting member rotates along with the first rotating member and pushes the abutting portion to rotate the second rotating member.

### BACKGROUND OF THE INVENTION

1. Field of the Invention

The present invention relates in general to a rotating mechanism, and more particularly, to a rotating mechanism of a camera to facilitate positioning of a lens assembly.

2. Description of the Related Art

Conventional cameras may have a rotatable lens assembly for users to take a picture using different optical effects. Referring to FIG. 1, the conventional camera has a lens assembly 1 rotatably connected to a housing 16 via a shaft 2 with rotation of the lens assembly 1 in the direction of the arrow. The lens assembly 1, however, has to be manually rotated to a specific position. This may be not convenient for users.

### SUMMARY OF THE INVENTION

Accordingly, an object of the present invention is to provide a rotating mechanism to facilitate a spring-out lens assembly design and positioning of a lens assembly. The rotating mechanism comprises a fixed member, a first rotating member, a second rotating member, a restricting member and a first resilient element. The second rotating member has an abutting portion, and the restricting member movably connects to the first rotating member and contacts the abutting portion. The first resilient element connects the fixed member and the first rotating member. Moreover, the first resilient element provides a spring force to rotate the first rotating member, wherein the restricting member rotates along with the first rotating member and pushes the abutting portion to rotate the second rotating member.

### DESCRIPTION OF THE DRAWINGS

The present invention will become more fully understood from the detailed description given hereinbelow and the accompanying drawings, given by way of illustration only and thus not intended, to be limitative of the present invention.

FIG. 1 is a perspective diagram of a conventional camera.

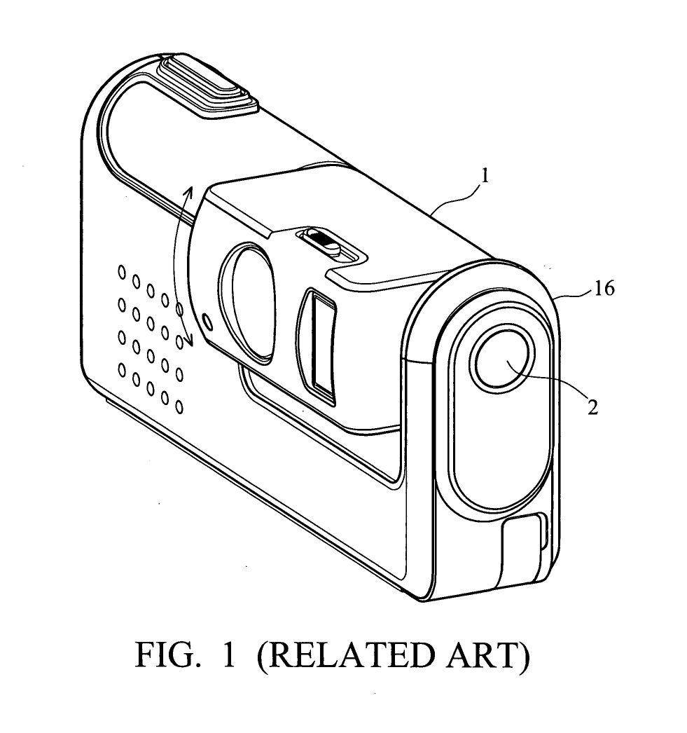

FIGS. 2a and 2b are perspective diagrams of the camera in accordance with the invention.

FIGS. 3a and 3b are exploded diagrams of the rotating mechanism in accordance with the invention.

FIG. 3c is a perspective diagram of FIG. 3b.

FIG. 4a is a perspective diagram illustrating the release member in the initial position.

FIG. 4b is a perspective diagram showing the release member engaged downward.

FIG. 4c is a perspective diagram illustrating the inclined angle a between the slanted surface and the moving direction of the slider.

FIG. 4d is a perspective diagram showing the lens assembly rotated to an angle of 90°.

FIG. 5 is a perspective diagram showing the protrusion located in the recess.

FIG. 6a is a perspective diagram showing the lens assembly rotating beyond 90°.

FIG. 6b is a perspective diagram showing the lens assembly rotating to the maximum angle of 270°.

### DETAILED DESCRIPTION OF THE INVENTION

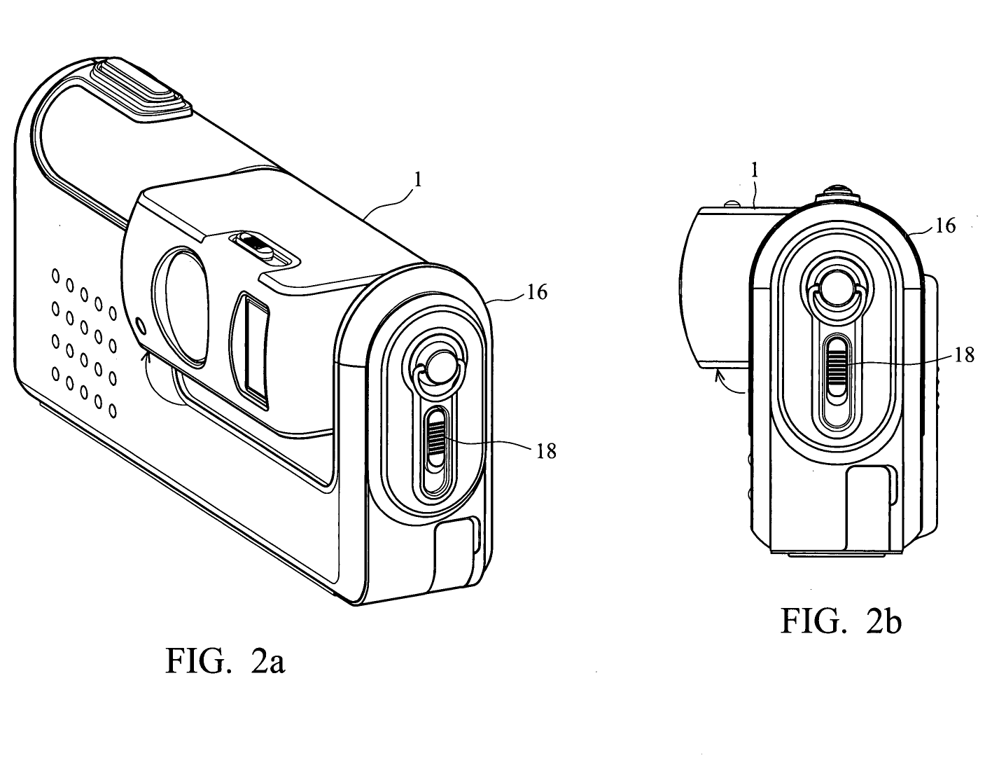

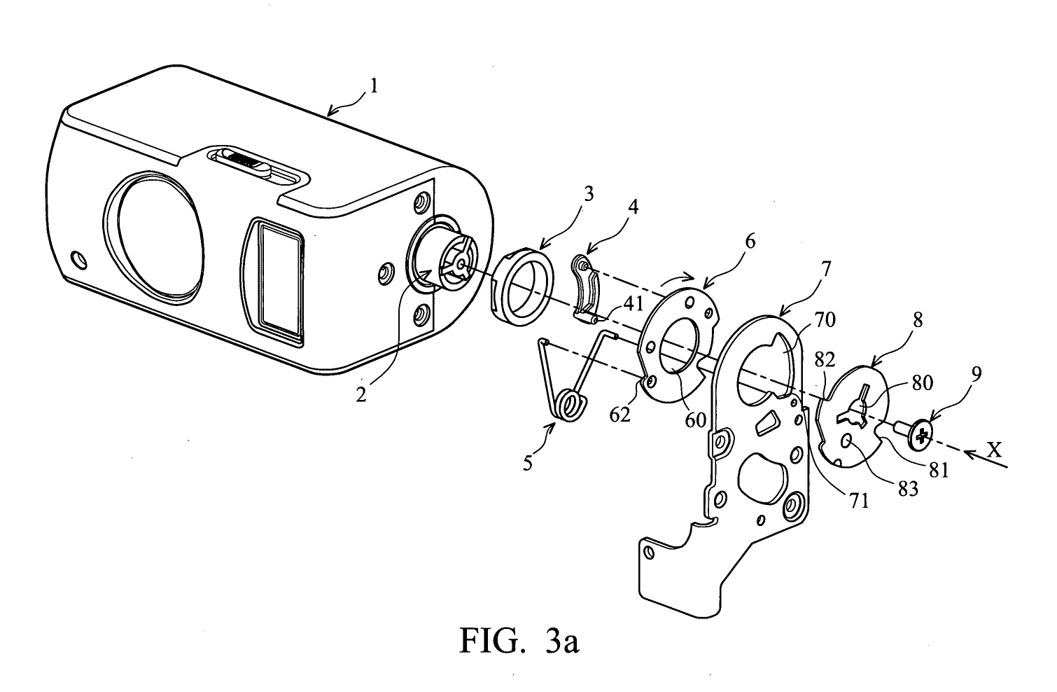

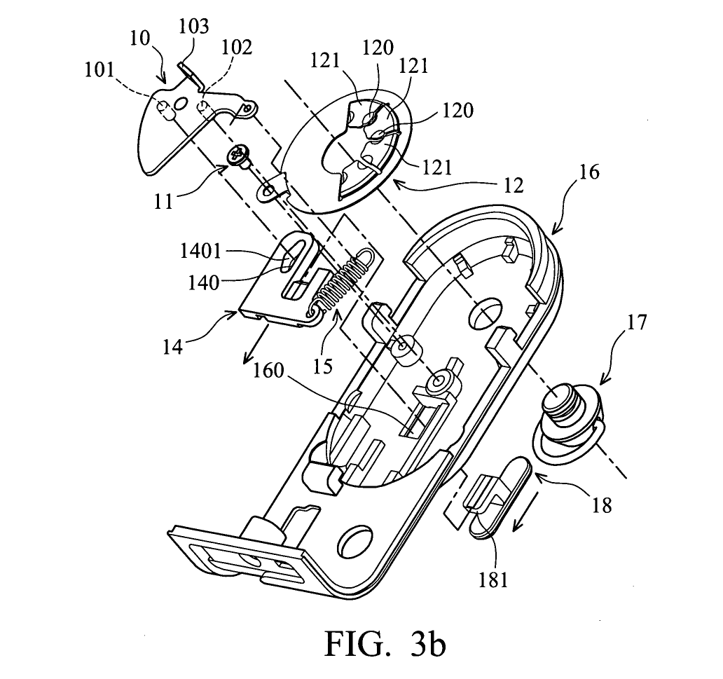

Referring to FIGS. 2a and 2b, the rotating mechanism for a camera lens assembly 1 automatically positions itself perpendicular to the housing 16 when the release member 18 is engaged. As shown in FIG. 3a, the rotating mechanism comprises a shaft 2, a bushing 3, a restricting member 4, a first resilient element 5, a first rotating member 6, a fixed member 7, a second rotating member 8 and a screw 9, wherein the shaft 2 is fixed to the lens assembly 1 and sequentially passes through the bushing 3, the third opening 60 of the first rotating member 6, and the second opening 70 of the fixed member 7. The shaft 2 is joined in the fourth opening 80 on the second rotating member 8 and secured by the screw 9. That is, the second rotating member 8, the shaft 2 and the lens assembly 1 are fixed. Moreover, the fixed member 7 is fixed to the housing 16, and the first rotating member 6 is rotatable on the shaft 2.

As shown in FIG. 3a, the first resilient element 5 is a torsion spring connecting the first rotating member 6 and the fixed member 7. Thus, the first resilient element 5 provides a spring force to the first rotating member 6 to push the lens assembly 1 into position. In FIG. 3a, the first rotating member 6 has a restraining portion 62, and the second rotating member 8 has a abutting portion 81 and a protrusion 83 disposed thereon. The restricting member 4 movably connects the first rotating member 6 and has a protruding end 41 passing through the second opening 70 and contacting the abutting portion 81. In X direction, when the release member 18 is engaged downward, the first rotating member 6 is rotated clockwise by the first resilient element 5, as the arrow shows. With the protruding end 41 contacting the abutting portion 81, the restricting member 4 rotates along with the first rotating member 6 and rotates the second rotating member 8 and the lens assembly 1.

Referring to FIGS. 3b and 3c, the rotating mechanism of the present invention further comprises a restraining member 10, a positioning member 12, a slider 14, a second resilient element 15, a release member 18 and a bolt 17. Before the lens assembly 1 is positioned, the lens assembly 1 is held in an initial position where the blocking portion 103 of the restraining member 10 abuts the restraining portion 62 of the first rotating member 6. The positioning member 12 is fixed to the housing 16 by the bolt 17 and a screw 11. The positioning member 12 has at least one metallic disc 121 with at least one recess 120 disposed thereon.

As shown in FIG. 3b, the release member 18 has a hook 181 passing through a first opening 160 on the housing 16. The hook 181 catches and moves the slider 14 sliding on the housing 16. The restraining member 10 has a pivot 102 connected to the housing 16, and the second resilient element 15 is a tension spring connecting the slider 14 and the restraining member 10. The slider 14 has a slot 140, and the restraining member 10 further has a post 101 movably disposed in the slot 140. When the release member 18 is engaged downward as the arrow indicates in FIG. 3b, the post 101 slides on the inner slanted surface 1401 of the slot 140, and the restraining member 10 is rotated on the pivot 102.

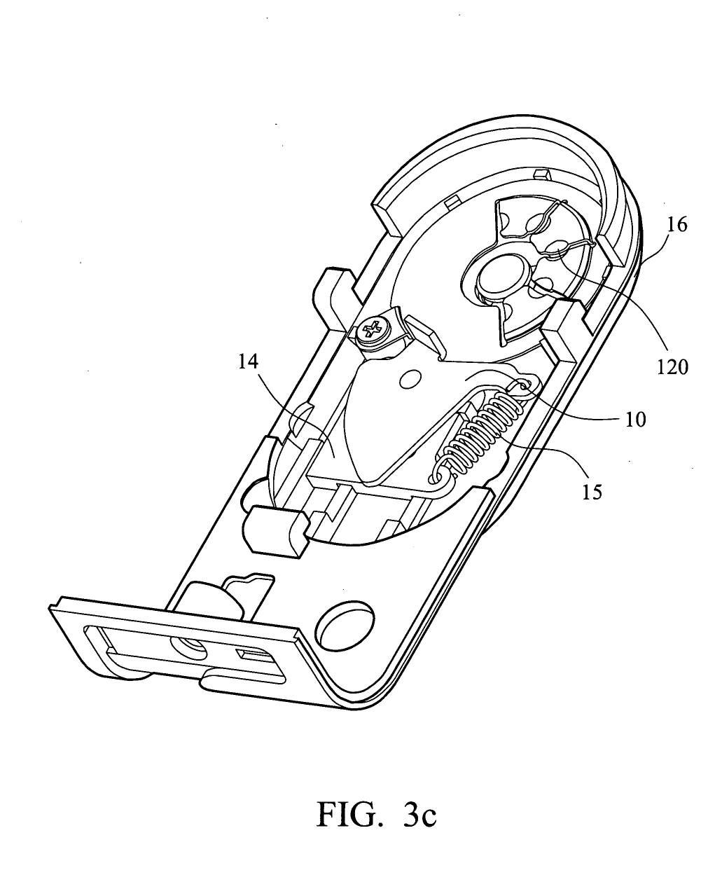

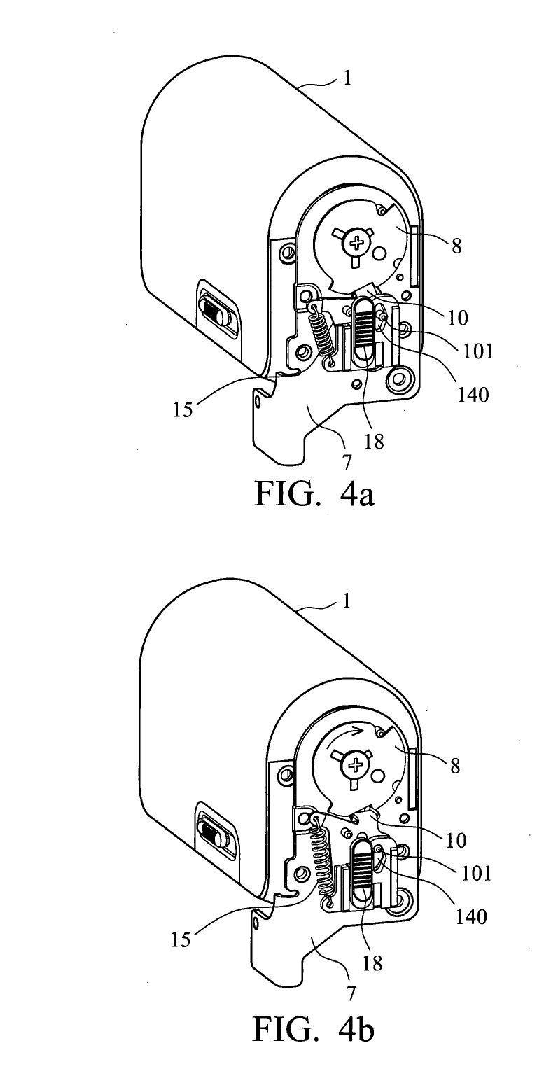

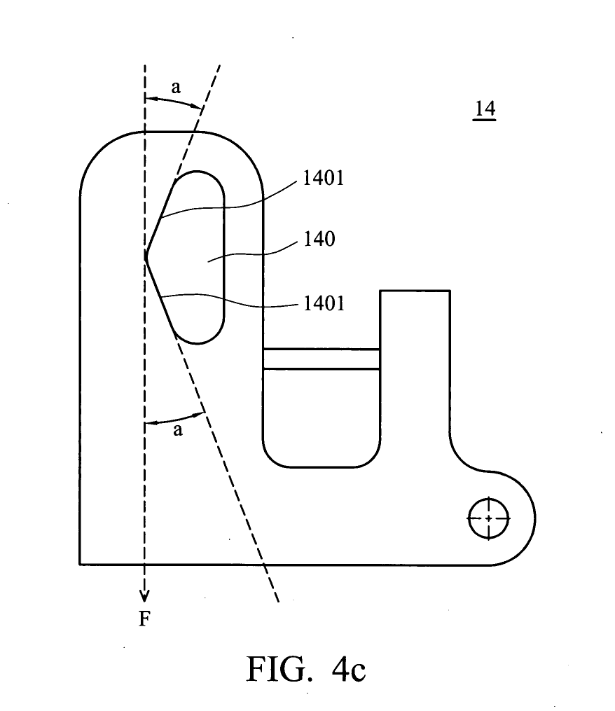

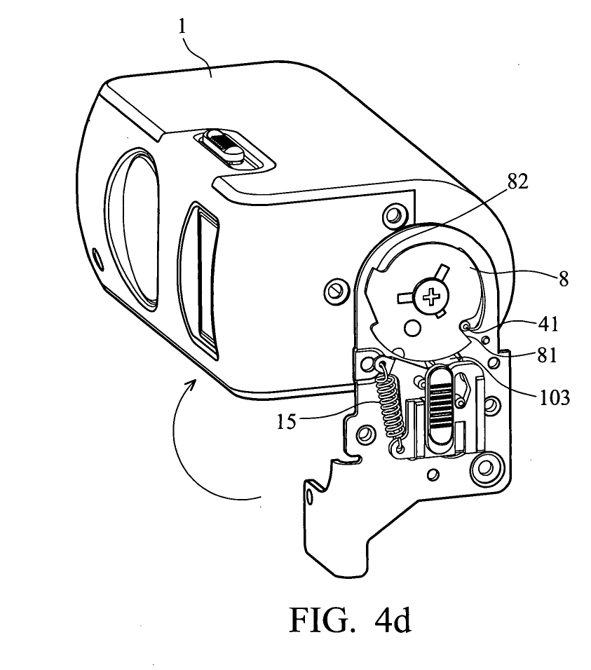

Referring to FIGS. 4a and 4b, when the release member 18 is engaged downward, the second resilient element 15 is extended and exerts a recovery spring force on the release member 18, which returns to the initial position. As shown in FIG. 4c, as the slanted surface 1401 and the moving direction F of slider 14 have an inclined angle a, the restraining member 10 always has less displacement than the slider 14 when the restraining member 10 is driven. It is therefore easier to engage the release member 18.

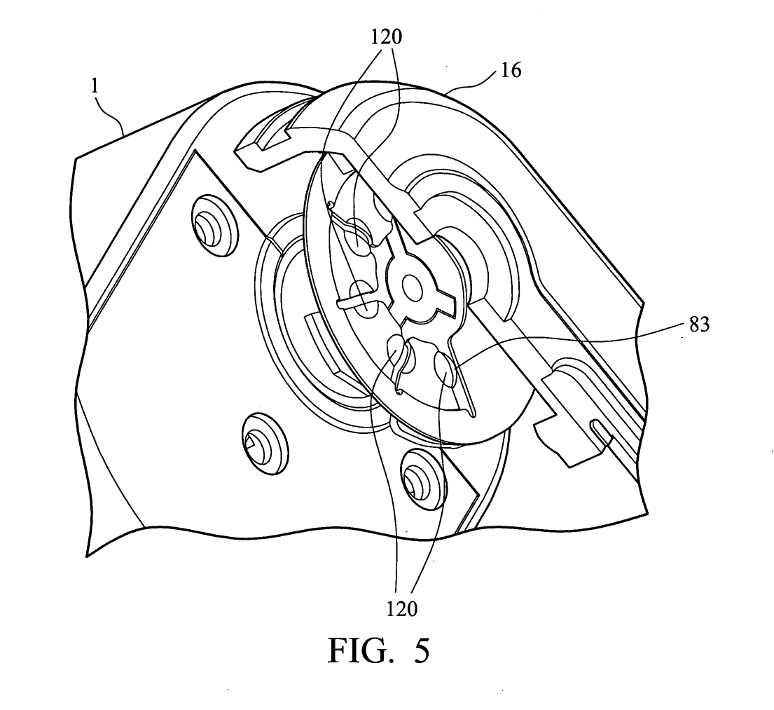

When the release member 18 is engaged downward, the slider 14 rotates the restraining member 10 on the pivot 102 such that the blocking portion 103 separates from the restraining portion 62. As shown in FIG. 4d, the first resilient element 5 applies spring force to rotate the first rotating member 6; meanwhile, the restricting member 4 rotates along with the first rotating member 6. Subsequently, with the protruding end 41 contacting the abutting portion 81, the second rotating member 8 and the lens assembly 1 are rotated to an angular displacement of 90°. Specifically, the protrusion 83 of the second rotating member 8 tightly contacts the metallic disc 121. The protrusion 83 slides on the metallic disc 121 when the lens assembly 1 rotates, wherein the metallic disc 121 is resilient and exert a recovery force on the second rotating member 8. The recesses 120 are disposed in some predetermined positions as shown in FIG. 5 such that the protrusion 83 is positioned in the recess 120 when the lens assembly 1 rotates to an angle of 90°.

The first rotating member 6, however, can only rotate between the initial position and a first position of 90°. As mentioned above, the restricting member 4 rotates along with the first rotating member 6. When the restricting member 4 abuts the restraining surface 71, the first rotating member 6 is held in the first position. As shown in FIG. 3a, the restraining surface 71 is on the inner surface of the second opening 70. When the first rotating member 6 rotates, the blocking portion 103 is propped and abutted by the fringe thereof.

The lens assembly 1 and the second rotating member 8 are manually rotatable from 90° to 270° according to this embodiment. As shown in FIG. 5, the positioning member 12 has several recesses 120 into which the protrusion 83 enters such that the lens assembly 1 arrives at a predetermined position.

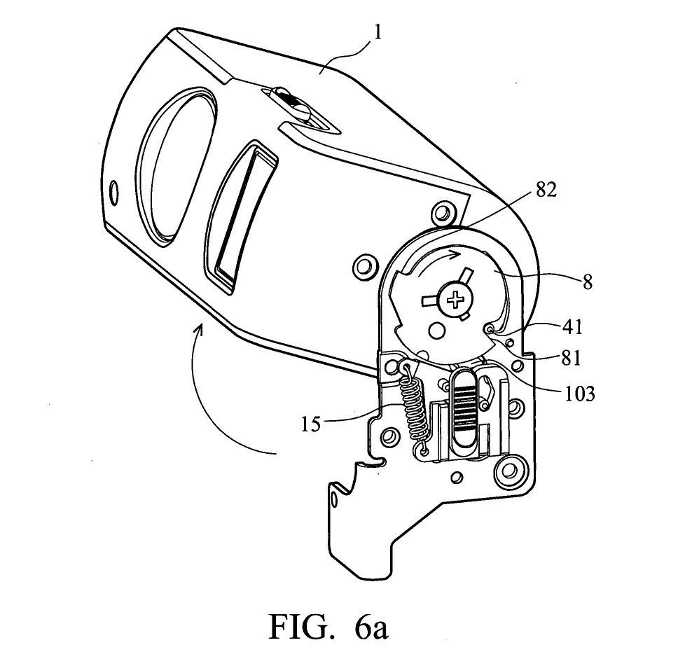

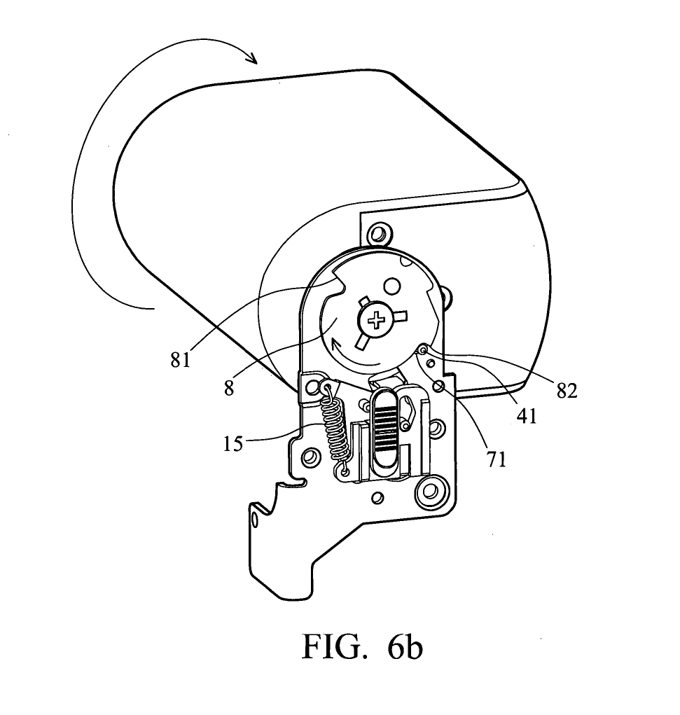

As shown in FIG. 4d, when the torsion spring 5 rotates the first rotating member 6 to 90°, the second rotating member 8 is in the first position. However, the second rotating member 8 can be further rotated manually to a maximum position of 270°. Referring to FIGS. 6a and 6b, when the lens assembly 1 rotates from 90° to 270°, the restricting member 4 separates from the abutting portion 81. When the lens assembly 1 rotates to the maximum position of 270°, the protruding end 41 is abutted by the restraining surface 71 on the fixed member 7 such that the contacting portion 82 of the second rotating member 8 is restricted by the protruding end 41. As a result, the second rotating member 8 is limited at the maximum position of 270° without further rotation.

In X direction as shown in FIG. 3a, the lens assembly 1 is returned to its initial position by manual counterclockwise rotation thereof. Thereby, the second rotating member 8 pushes the restricting member 4 by the abutting portion 81 and rotates the first rotating member 6 counterclockwise. Moreover, as the first rotating member 6 returns to the initial position, the blocking portion 103 of the restraining member 10 spontaneously returns and abuts the restraining portion 62 due to the spring force of the second resilient element 15. Thus, the lens assembly 1 is returned to its original position. In summary, the present invention provides a rotating mechanism to facilitate positioning of the lens assembly in a predetermined position.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation to encompass all such modifications and similar arrangements.

1. A rotating mechanism, comprising:
a fixed member;
a first rotating member;
a second rotating member comprising an abutting portion;
a restricting member movably connected to the first rotating member and contacting the abutting portion;
a first resilient element connected to the fixed member and the first rotating member, providing a spring force rotating the first rotating member, wherein the restricting member rotates along with the first rotating member and pushes the abutting portion to rotate the second rotating member.

2. The rotating mechanism as claimed in claim 1, wherein the first resilient element is a torsion spring.

3. The rotating mechanism as claimed in claim 1 further comprising a housing and a restraining member rotatably connected thereto, wherein the first rotating member comprises a restraining portion abutting the restraining member in an initial position.

4. The rotating mechanism as claimed in claim 3 further comprising a slider movably disposed on the housing and connected to the restraining member, wherein the slider separates the restraining member from the restraining portion such that the first resilient element separates the first rotating member from an initial position.

5. The rotating mechanism as claimed in claim 4 further comprising a release member, wherein the housing comprises a first opening through which the release member passes, and the release member is movably disposed on a side of the housing and connected to the slider such that the slider moves therewith.

6. The rotating mechanism as claimed in claim 4 further comprising a second resilient element connecting the restraining member and the slider.

7. The rotating mechanism as claimed in claim 6, wherein after the first rotating member leaves the initial position, the second resilient element provides spring force to abut the restraining member with the first rotating member and move the slider toward the first rotating member.

8. The rotating mechanism as claimed in claim 6, wherein the second resilient element is a tension spring.

9. The rotating mechanism as claimed in claim 4, wherein the slider comprises a slot, and the restraining member comprises a post located in the slot and connected to the slider.

10. The rotating mechanism as claimed in claim 9, wherein the slot comprises a slanted surface with the post sliding thereon, and the slanted surface is inclined at an angle with respect to the moving direction of the slider, wherein the angle is between 0° and 90°.

11. The rotating mechanism as claimed in claim 1 further comprising a shaft fixed to the second rotating member, both manually rotatable when the first and the second rotating members are in a first position.

12. The rotating mechanism as claimed in claim 11, wherein the fixed member comprises a restraining surface abutting the restricting member and holding the first rotating member in the first position.

13. The rotating mechanism as claimed in claim 12, wherein the abutting portion separates from the restricting member when the second rotating member rotates past the first position, and the second rotating member has a contacting portion pushing the restricting member to contact the restraining surface such that the second rotating member is restricted in a maximum position.

14. The rotating mechanism as claimed in claim 12, wherein the fixed member further comprises a second opening with the restraining surface defined thereon.

15. The rotating mechanism as claimed in claim 11, wherein the rotating member comprises a third opening with the shaft passes therethrough.

16. The rotating mechanism as claimed in claim 1 further comprising a positioning member fixed on the housing, comprising a recess, and the second rotating member comprising a projection capable of being located in the recess when the second rotating member rotates.

17. The rotating mechanism as claimed in claim 16, wherein the positioning member comprises a plurality of recesses.

18. The rotating mechanism as claimed in claim 16, wherein the positioning member further comprises a metallic disc with the recess disposed thereon.

19. The rotating mechanism as claimed in claim 17, wherein the metallic disc contacts and exerts a spring force on the second rotating member.

20. The rotating mechanism as claimed in claim 1, wherein the fixed member has a second opening through which a protruding end of the restricting member passes.
